(19) United States
(12) Patent Application Publication
(10) Pub. No.: US 2020/0109768 A1
(43) Pub. Date: Apr. 9, 2020

(54) REDUCTION GEAR

(71) Applicant: SHIROKI CORPORATION, Fujisawa-shi (JP)

(72) Inventors: Noriyuki SAKURAI, Fujisawa-shi (JP); Mitsugu TANIGUCHI, Fujisawa-shi (JP); Yuta MURAKAMI, Nagoya-shi, Aichi-ken (JP)

(73) Assignee: SHIROKI CORPORATION, Fujisawa-shi (JP)

(21) Appl. No.: 16/589,548

(22) Filed: Oct. 1, 2019

(30) Foreign Application Priority Data
Oct. 5, 2018 (JP) 2018-190221

(51) Int. Cl. F16H 1/20

(52) U.S. Cl. CPC F16H 1/203

(57) ABSTRACT

A reduction gear includes a housing, a worm, a worm wheel, and a drive gear. The worm is located in the housing and rotates by power of a motor. The worm wheel is moved in cooperation with the worm. The drive gear is moved in cooperation with the worm wheel. The drive gear overlaps the worm. The housing includes a partition wall located between the worm and the drive gear.

### BACKGROUND

### 1. Field

The following description relates to a reduction gear for a motor.

2. Description of Related Art

Japanese Laid-Open Patent Publication No. 2003-134723 describes a known reduction gear for a motor.

The reduction gear described in the above publication includes a worm, a worm wheel, and a drive gear. The worm is rotated by the motor. The worm wheel is moved in cooperation with the worm, and the drive gear is moved in cooperation with the worm wheel.

The drive gear may not be rotated stably in the structure of the conventional reduction gear.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A reduction gear that stabilizes rotation of the drive gear includes a housing, a worm, a worm wheel, and a drive gear. The worm is located in the housing and rotates by power of a motor. The worm wheel is moved in cooperation with the worm. The drive gear is moved in cooperation with the worm wheel. The drive gear overlaps the worm. The housing includes a partition wall located between the worm and the drive gear. With this structure, the drive gear is supported by a larger surface than when the partition wall is not included between the worm and the drive gear. This stabilizes rotation of the drive gear.

Other features and aspects will be apparent from the following detailed description, the drawings, and the claims.

### BRIEF DESCRIPTION OF THE DRAWINGS

FIG. 1 is a plan view of a motor unit.

FIG. 2 is a perspective view of a reduction gear.

FIG. 3 is an exploded perspective view of the reduction gear.

FIG. 4 is a plan view of the reduction gear.

FIG. 5 is a schematic diagram illustrating the positional relationship of a first gear, a third gear, and a worm in accordance with the present embodiment.

FIG. 6 is a schematic diagram illustrating the positional relationship of a first gear, a third gear, and a worm in accordance with a referential embodiment.

FIG. 7 is a perspective view of a housing taken from the side of an opening.

FIG. 8 is a perspective view of the housing taken from a side opposite to the opening.

FIG. 9 is a cross-sectional view taken along line IX-IX in FIG. 4.

FIG. 10 is a cross-sectional view taken along line X-X in FIG. 4.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

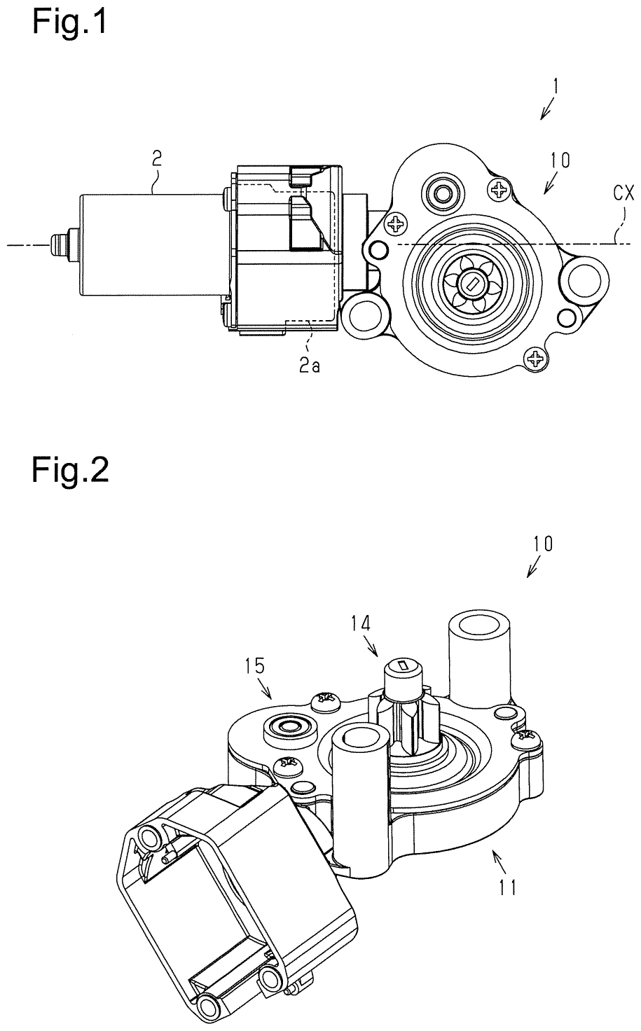

FIG. 1 shows one example of a motor unit 1. In one example, the motor unit 1 is coupled to a vehicle seat. For example, the motor unit 1 serves as a power generator of an actuator for changing an inclination angle of a seatback. In another example, the motor unit 1 serves as a power generator of an actuator for moving a seatback in a vertical direction. The motor unit 1 includes a motor 2 and a reduction gear 10. The reduction gear 10 reduces the rotation speed of an output shaft of the motor 2. The reduction gear 10 is coupled to the motor 2.

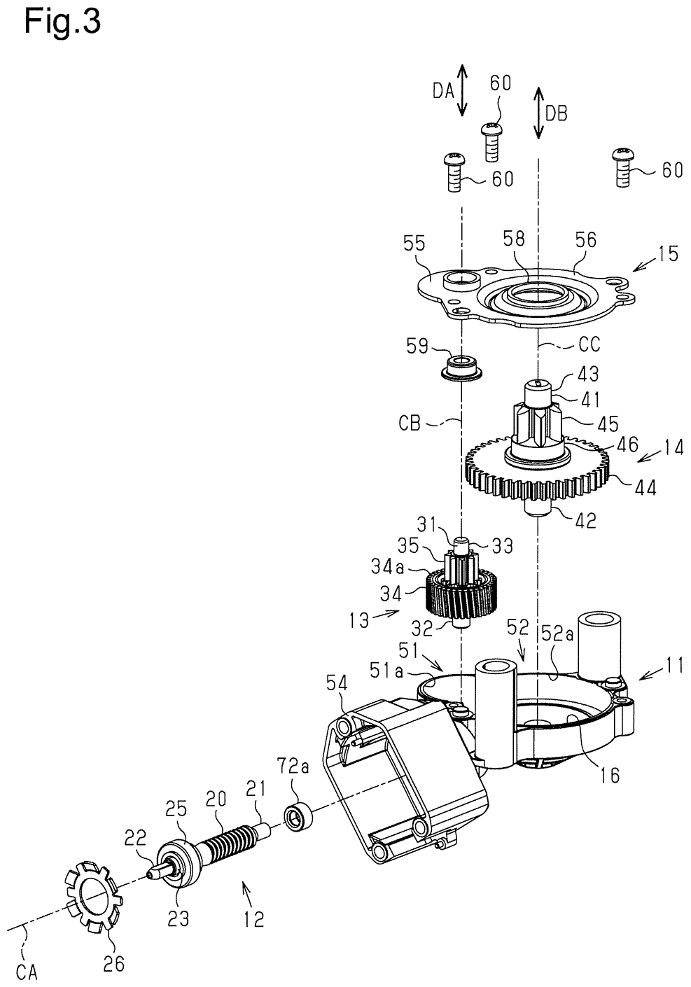

The reduction gear 10 will now be described with reference to FIGS. 2 to 10. FIG. 2 is a perspective view of the reduction gear 10, and FIG. 3 is an exploded perspective view of the reduction gear 10.

As shown in FIG. 3, the reduction gear 10 includes a housing 11, a worm 12, a worm wheel 13, and a drive gear 14. The worm wheel 13 is moved in cooperation with the worm 12, and the drive gear 14 is moved in cooperation with the worm wheel 13. The reduction gear 10 may include a cover 15 that is coupled to the housing 11.

The worm 12 is located in the housing 11. Specifically, the worm 12 is accommodated in a third accommodation portion 53 of the housing 11.

The worm 12 includes a worm gear portion 20, a first end 21, a second end 22, and a worm support portion 23. The first end 21 is located at one end of the worm gear portion 20. The second end 22 is located at a side of the worm gear portion 20 opposite to the first end 21. The worm support portion 23 is located between the worm gear portion 20 and the second end 22.

The first end 21 of the worm 12 is supported by the housing 11. The second end 22 of the worm 12 is connected to an output shaft of the motor 2. A roller 25 is coupled to the worm support portion 23. The worm support portion 23 is rotatably supported by the roller 25 in the housing 11. The worm 12 and the roller 25 are held by a tooth washer 26 and accommodated in the third accommodation portion 53 of the housing 11. This restricts separation of the worm 12 and the roller 25 from the third accommodation portion 53. The worm 12 is joined with the output shaft so that a worm rotation axis CA coincides with a rotation axis CX of the output shaft of the motor 2 (refer to FIG. 10).

The worm wheel 13 includes a first shaft 31, a first gear 34, and a second gear 35. The first shaft 31 has a first rotation axis CB. The first gear 34 is arranged on the first shaft 31 and rotates about the first rotation axis CB. The first gear 34 is meshed with the worm 12. The second gear 35 is arranged on the first shaft 31 and rotates about the first rotation axis CB. The second gear 35 has a smaller diameter than the first gear 34.

The first shaft 31 includes a first end 32 and a second end 33. The first end 32 is supported by the housing 11. The second end 33 is supported by the cover 15. In the present embodiment, the second gear 35 is arranged on the first shaft 31 closer to the second end 33 than the first gear 34 in a direction of the rotation axis CB. A second shaft 41 includes a first end 42, a second end 43, and an intermediate portion 46. The first end 42 is supported by the housing 11. The second end 43 is located outside the cover 15. The intermediate portion 46 of the second shaft 41 is located between a coupling portion of a third gear 44 and a coupling portion of a fourth gear 45. The intermediate portion 46 is supported by the cover 15.

The drive gear 14 includes the second shaft 41 and the third gear 44. The second shaft 41 has a second rotation axis CC. In the present embodiment, the drive gear 14 further includes the fourth gear 45. The third gear 44 is arranged on the second shaft 41 and rotates about the second rotation axis CC. The third gear 44 is meshed with the second gear 35. The third gear 44 has a larger diameter than the first gear 34. The fourth gear 45 is arranged on the second shaft 41 and rotates about the second rotation axis CC. The fourth gear 45 transmits rotational power to an actuator or a power transmission member other than the reduction gear 10. The fourth gear 45 is located outside the cover 15.

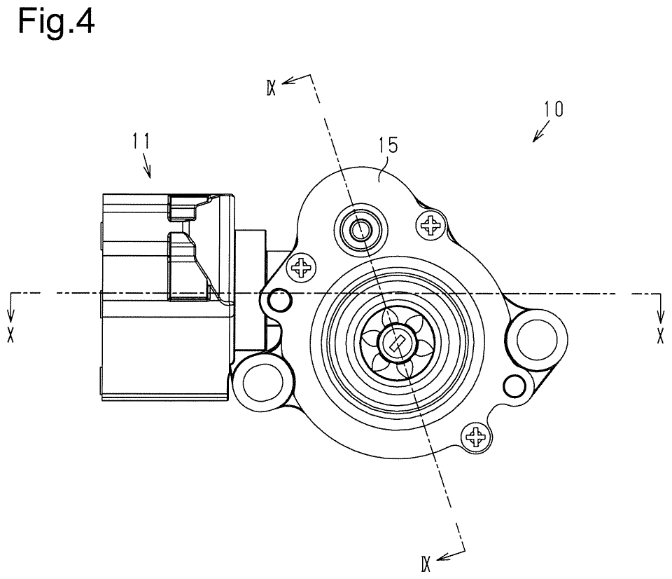

The positional relationship of the worm wheel 13, the drive gear 14, and the worm 12 will now be described with reference to FIGS. 4 to 6.

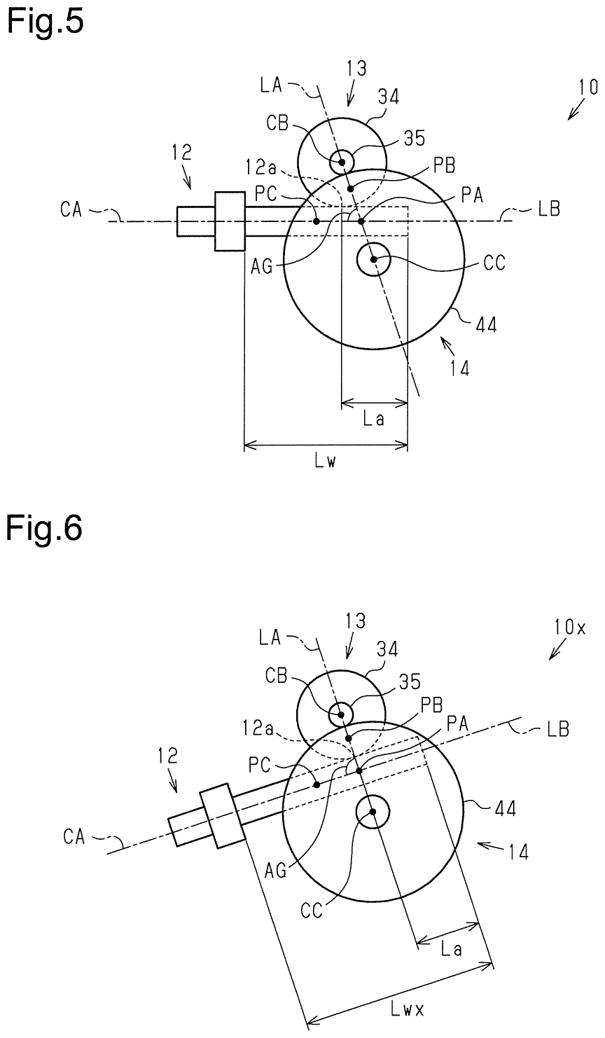

The first shaft 31 and the second shaft 41 are arranged so that the first rotation axis CB of the first shaft 31 is parallel to the second rotation axis CC of the second shaft 41. The drive gear 14 partially overlaps the worm wheel 13 when viewed in the direction of the first rotation axis CB (hereafter, “first direction DA”). Specifically, part of the third gear 44 of the drive gear 14 overlaps the first gear 34 when viewed in the first direction DA (refer to FIG. 5). Further, the drive gear 14 overlaps the worm 12 in the first direction DA. Specifically, the third gear 44 of the drive gear 14 at least partially overlaps the worm 12 when viewed in the first direction DA.

As shown in FIG. 5, the worm 12 may be located between the first gear 34 and the second shaft 41. Further, the worm 12 includes a meshing portion 12a meshed with the first gear 34 and located on an outer circumferential surface of the first gear 34 when viewed in the first direction DA.

As shown in FIG. 5, the worm 12 may be arranged so that a first straight line LA, which orthogonally intersects with the first rotation axis CB and the second rotation axis CC, intersects diagonally with a second straight line LB, which extends along the worm rotation axis CA of the worm 12 and so that an angle AG between the first straight line LA and the second straight line LB is less than 90 degrees (hereafter, “worm arrangement”). When the intersection of the first straight line LA and the second straight line LB defines an intersecting point PA, the phrase “angle AG between the first straight line LA and the second straight line LB” refers to an angle between a line segment connecting the intersecting point PA and a point PB that is closer to the first rotation axis CB than the intersecting point PA on the first straight line LA, and a line segment connecting the intersecting point PA and a point PC that is closer to the motor 2 than the intersecting point PA on the second straight line LB.

FIG. 6 shows a referential reduction gear 10x for comparison with the reduction gear 10 in accordance with the present embodiment. In the referential reduction gear 10x, “angle AG between the first straight line LA and the second straight line LB” is set to 90 degrees. In the reduction gear 10 of the present embodiment and the referential reduction gear 10x, length La from the meshing portion 12a to the first end 21 of the worm 12 is the same. In this case, as the comparison between FIGS. 5 and 6 indicates, length Lw of the worm 12 arranged in the above worm arrangement is shorter than length Lwx of the referential worm 12.

The housing 11 accommodates the worm wheel 13, the drive gear 14, and the worm 12.

The housing 11 includes a first accommodation portion 51, a second accommodation portion 52, and the third accommodation portion 53. The first accommodation portion 51 accommodates the first gear 34 and the second gear 35. The second accommodation portion 52 accommodates at least part of the third gear 44, and the third accommodation portion 53 accommodates the worm 12. The housing 11 may further include a motor coupling portion 54. For example, when the motor 2 is a brushed motor, the motor coupling portion 54 accommodates a power feeding portion 2a that includes a commutator and brushes. The housing 11 is fixed to the motor 2 when the motor coupling portion 54 is fastened by a fastener to the power feeding portion 2a of the motor 2 in a state in which the power feeding portion 2a of the motor 2 is accommodated in the motor coupling portion 54.

The cover 15 covers an opening 16 of the housing 11. The cover 15 is coupled to the housing 11 by fasteners 60.

The cover 15 includes a first cover portion 55 and a second cover portion 56. The first cover portion 55 covers a first opening 51a of the first accommodation portion 51. The second cover portion 56 covers a second opening 52a of the second accommodation portion 52. The first cover portion 55 includes a surface that opposes a first bottom surface 63 (described later) of the first accommodation portion 51. The second cover portion 56 includes a surface that opposes a second bottom surface 67 (described later) of the second accommodation portion 52.

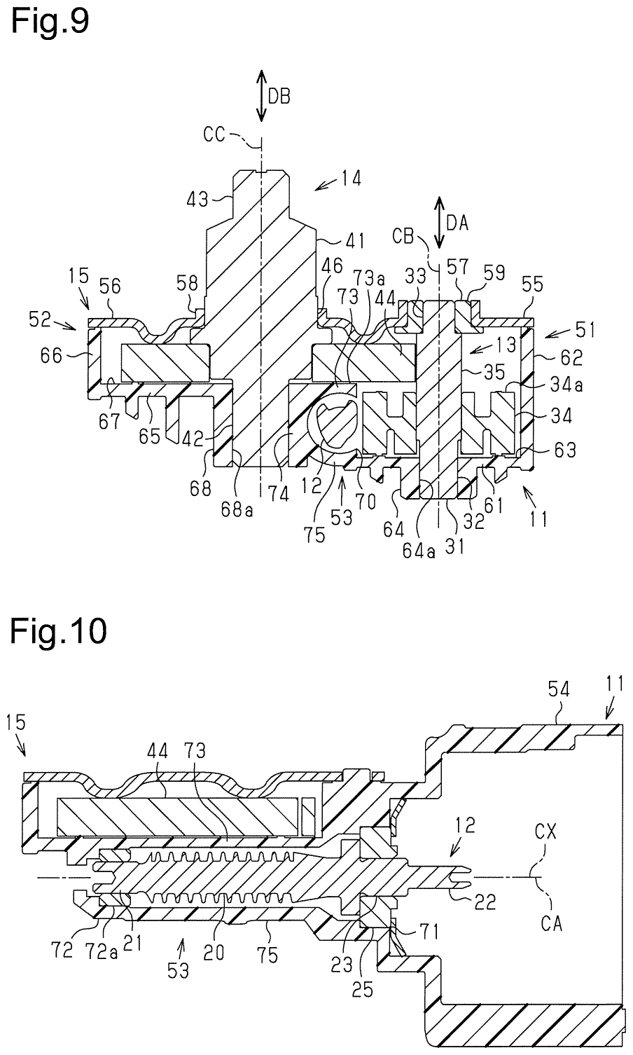

The first cover portion 55 includes a first bearing 57 (refer to FIG. 9) that receives the second end 33 of the first shaft 31. The first bearing 57 is formed by, for example, a bushing 59 that is coupled to the first cover portion 55. The second cover portion 56 includes a second bearing 58 that receives the intermediate portion 46 of the second shaft 41. The second bearing 58 includes a through hole provided in the second cover portion 56.

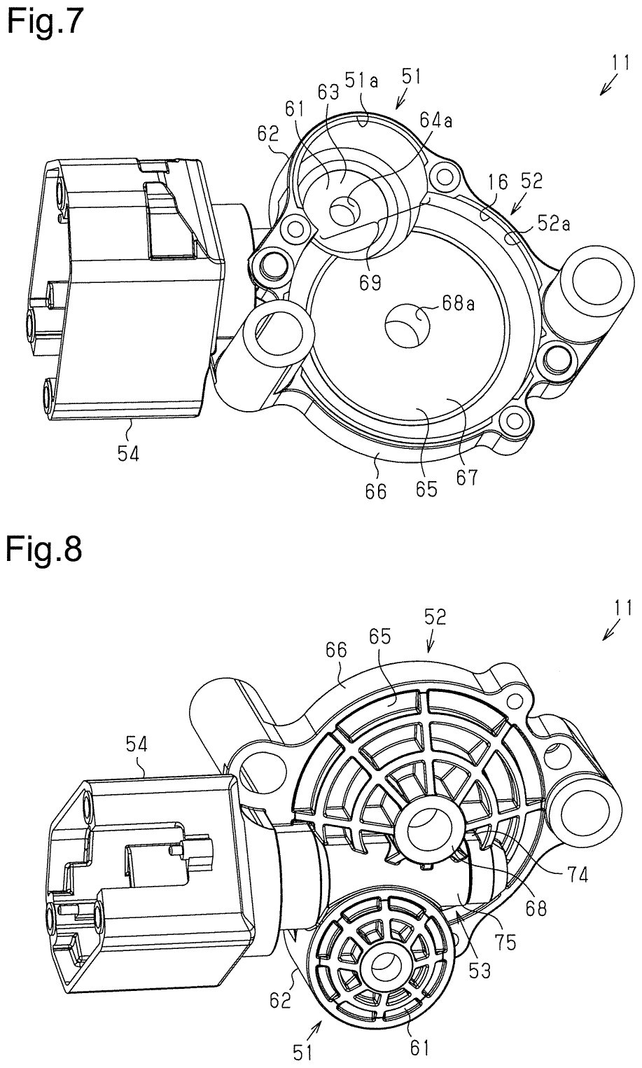

The structure of the housing 11 will now be described with reference to FIGS. 7 to 10.

The housing 11 includes a partition wall 73 located between the worm 12 and the drive gear 14. In the present embodiment, the partition wall 73 is formed integrally with other portions of the housing 11 (portions excluding partition wall 73). One example of the housing 11 will now be described.

As shown in FIG. 7, the first accommodation portion 51 includes a first bottom wall 61 and a first circumferential wall 62. The first accommodation portion 51 includes an open end opposite to the first bottom wall 61 in the first direction DA. The open end defines the first opening 51a. The first opening 51a is large enough to receive the first gear 34.

The first circumferential wall 62 is cylindrical so as to face the toothed surface of the first gear 34 and the toothed surface of the second gear 35. The first bottom wall 61 includes the first bottom surface 63 that opposes the first gear 34. The first bottom wall 61 includes a third bearing 64 that receives the first end 32 of the first shaft 31. The third bearing 64 includes a first insertion hole 64a into which the first end 32 of the first shaft 31 is inserted.

As shown in FIG. 7, the second accommodation portion 52 includes a second bottom wall 65 and a second circumferential wall 66. The second accommodation portion 52 includes an open end opposite to the second bottom wall 65 in a direction of the second rotation axis CC (hereafter, “second direction DB”). The open end defines the second opening 52a. The second opening 52a is large enough to receive the third gear 44. The first opening 51a is connected with the second opening 52a. The first opening 51a and the second opening 52a define the opening 16 of the housing 11. When viewed in the second direction DB, the second bottom wall 65 has a shape obtained by cutting out an overlapping portion of a first circle about the second rotation axis CC and a second circle about the first rotation axis CB.

The second bottom wall 65 includes the second bottom surface 67 that opposes the third gear 44. The second circumferential wall 66 faces the toothed surface of the third gear 44. The portion of the first circumferential wall 62 extending into the second circumferential wall 66 is cut out. The portion of the second circumferential wall 66 extending into the first circumferential wall 62 is cut out. The first accommodation portion 51 is connected with the second accommodation portion 52 through the cutout portions of the first circumferential wall 62 and the second circumferential wall 66 (hereafter, “cutout portion 69”). Part of the third gear 44 extends out of the cutout portion 69 into the first accommodation portion 51 and is meshed with the second gear 35.

The second bottom wall 65 includes a fourth bearing 68 that receives the first end 42 of the second shaft 41. The fourth bearing 68 projects from a surface of the second bottom wall 65 opposite to the second bottom surface 67. The fourth bearing 68 includes a second insertion hole 68a into which the first end 42 of the second shaft 41 is inserted.

As shown in FIG. 8, the third accommodation portion 53 is arranged along the second bottom wall 65 of the second accommodation portion 52 so as to contact the first circumferential wall 62 of the first accommodation portion 51.

Further, as shown in FIG. 9, the third accommodation portion 53 is located between the first shaft 31 and the second shaft 41. The third accommodation portion 53 is connected to the first accommodation portion 51 through a connection portion 70 (refer to FIG. 9). The worm 12 is exposed from the connection portion 70 and meshed with the first gear 34 in the first accommodation portion 51.

The third accommodation portion 53 includes a worm opening 71 that opens in a direction of the worm rotation axis CA. The third accommodation portion 53 includes a bearing 72 at the side opposite to the worm opening 71 in the direction of the worm rotation axis CA to receive the worm 12. The bearing 72 includes a bearing member 72a that receives the first end portion 21 of the worm 12. When the housing 11 includes the motor coupling portion 54 like in the present embodiment, the worm opening 71 is connected to the motor coupling portion 54.

As shown in FIGS. 9 and 10, the third accommodation portion 53 includes the partition wall 73 located between the worm 12 and the drive gear 14. Specifically, the partition wall 73 partitions the worm 12 and the third gear 44. The partition wall 73 of the third accommodation portion 53 forms part of the second bottom wall 65. Further, the partition wall 73 includes an opposing surface 73a that is part of the second bottom surface 67 and opposes the third gear 44. The second bottom surface 67 is flat. The second bottom surface 67 is located closer to the third gear 44 in the second direction DB than a surface 34a of the first gear 34 opposing the third gear 44.

The third accommodation portion 53 may include a side wall 74. The side wall 74 is located between the second shaft 41 and the first gear 34. Specifically, the side wall 74 is located on the side of the worm 12 opposite to the connection portion 70 and extends in the direction of the worm rotation axis CA. The side wall 74 may extend from the fourth bearing 68, which receives the second shaft 41, along the worm rotation axis CA.

As shown in FIG. 10, the third accommodation portion 53 may further include a third bottom wall 75 located on the side of the worm 12 opposite to the partition wall 73 and extending in the direction of the worm rotation axis CA.

The operation of the present embodiment will now be described. As described above, the housing 11 includes the partition wall 73 located between the worm 12 and the drive gear 14. The third gear 44 is supported by a larger surface compared to a structure that is less the partition wall 73 such that the worm 12 is exposed to the second accommodation portion 52. If there is no partition wall 73, the rotation center of the third gear 44 may not be stable when the third gear 44 rotates. However, in the present embodiment, the partition wall 73 enlarges the surface supporting the third gear 44. This stabilizes rotation of the third gear 44.

The present embodiment has the following advantages.

(1) In the reduction gear 10, the drive gear 14 overlaps the worm 12. The housing 11 includes the partition wall 73 located between the worm 12 and the drive gear 14. With this structure, the surface that supports the drive gear 14 is larger than when the partition wall 73 is not included between the worm 12 and the drive gear 14. This stabilizes rotation of the drive gear 14.

(2) In the reduction gear 10, the worm wheel 13 includes the first shaft 31, the first gear 34 that is meshed with the worm 12, and the second gear 35. The drive gear 14 includes the third gear 44 that is meshed with the second gear 35. In the reduction gear 10, the housing 11 includes the partition wall 73 and the side wall 74. The side wall 74, which is located between the second shaft 41 and the worm 12, extends along the worm 12 from the fourth bearing 68, which receives the second shaft 41. With this structure, part of the side wall 74 forms the fourth bearing 68. This reduces the size of the reduction gear 10 as a whole.

(3) The partition wall 73 may include the opposing surface 73a that opposes the third gear 44. The housing 11 includes the bottom surface 67 that opposes the third gear 44. The opposing surface 73a of the partition wall 73 forms part of the second bottom surface 67 (bottom surface) of the housing 11. The second bottom surface 67 (bottom surface) is located at a position closer to the third gear 44 than the surface of the first gear 34 that opposes the third gear 44 in the direction of the second rotation axis CC. This structure prevents interference between the third gear 44 and the first gear 34.

(4) In the present embodiment, the worm 12 is located between the first gear 34 and the second shaft 41.

This structure reduces the size of the reduction gear 10 as a whole.

(5) A straight line that orthogonally intersects with the first rotation axis CB and the second rotation axis CC defines the first straight line LA. A straight line extending along the worm rotation axis CA of the worm 12 defines the second straight line LB. The worm 12 may be arranged so that the first straight line LA diagonally intersects with the second straight line LB and so that angle AG between the first straight line LA and the second straight line LB is less than 90 degrees. In this case, the worm 12 can be shortened compared with a case in which the worm 12 is arranged so that angle AG between the first straight line LA and the second straight line LB is 90 degrees.

### Other Embodiments

The above embodiment is not limited to the above configuration example. The above embodiment may be changed as described below. The same reference numerals are given to those components that are the same as the corresponding components of the above embodiment.

In the present embodiment, the partition wall 73 is formed integrally with other portions of the housing 11. Instead, the portion including the partition wall 73 may be formed as a member separate from the housing 11. For example, a plate forming the second bottom surface 67 including the opposing surface 73a of the partition wall 73 may be coupled to the bottom of the second accommodation portion 52.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A reduction gear, comprising:
a housing;
a worm located in the housing and rotates by power of a motor;
a worm wheel moved in cooperation with the worm; and
a drive gear moved in cooperation with the worm wheel, wherein
the drive gear overlaps the worm, and
the housing includes a partition wall located between the worm and the drive gear.

2. The reduction gear according to claim 1, wherein
the worm wheel includes a first shaft having a first rotation axis, a first gear arranged on the first shaft and meshed with the worm, and a second gear arranged on the first shaft,
the drive gear includes a second shaft having a second rotation axis and a third gear arranged on the second shaft and meshed with the second gear, and
the housing includes the partition wall and a side wall that is located between the second shaft and the worm and extends along the worm from a bearing receiving the second shaft.

3. The reduction gear according to claim 2, wherein
the partition wall includes an opposing surface that opposes the third gear,
the housing includes a bottom surface that opposes the third gear,
the opposing surface of the partition wall forms part of the bottom surface of the housing, and
the bottom surface is located at a position closer to the third gear than a surface of the first gear that opposes the third gear in a direction of the second rotation axis.

4. The reduction gear according to claim 2, wherein the worm is located between the first gear and the second shaft.

5. The reduction gear according to claim 4, wherein
a straight line that orthogonally intersects with the first rotation axis and the second rotation axis defines a first straight line, p1 a straight line that extends along a rotation axis of the worm defines a second straight line, and
the worm is arranged so that the first straight line diagonally intersects with the second straight line and so that an angle between the first straight line and the second straight line is less than 90 degrees.
